(19) United States
(12) Patent Application Publication
(10) Pub. No.: US 2018/0349968 A1
(43) Pub. Date: Dec. 6, 2018

(54) SYSTEMS AND METHODS FOR PRODUCT REVIEW MANAGEMENT WITH DISTRIBUTED DATABASE

(71) Applicant: Walmart Apollo, LLC, Bentonville, AR (US)

(72) Inventors: John J. O'Brien, Farmington, AR (US); Bruce W. Wilkinson, Rogers, AR (US); Brian G. McHale, Chadderton Oldham (GB); Robert L. Cantrell, Herndon, VA (US); Joseph Jurich, Jr., Molino, FL (US); Todd D. Mattingly, Bentonville, AR (US)

(21) Appl. No.: 15/996,077

(22) Filed: Jun. 1, 2018

Related U.S. Application Data
(60) Provisional application No. 62/514,522, filed on Jun. 2, 2017.

(51) Int. Cl. G06Q 30/02; G06Q 30/06; G06Q 20/38; H04L 9/06

(52) U.S. Cl. CPC G06Q 30/0282; G06Q 30/0643; H04L 67/104; G06Q 20/3829; H04L 9/0637; G06Q 20/3825

(57) ABSTRACT

Systems, apparatuses, and methods are provided herein for authenticated customer retail product review management. A system comprises a communication device configured to communicate nodes of a distributed transaction ledger over a network, wherein the distributed transaction ledger comprises digital product purchase records associated with a plurality of entities and a control circuit configured to receive a private key and a public key associated with a user, index transactions associated with the user in the distributed transaction ledger, determine products owned by the user based on the transactions associated with the user, display products owned by the user in a customer review user interface, receive a product review for a product owned by the user via the customer review user interface, generate a product review record based on the product review, and send the product review record to a distributed database as an update to the distributed database.

### CROSS-REFERENCE TO RELATED APPLICATION

This application claims the benefit of the following U.S. Provisional Application No. 62/514,522 filed Jun. 2, 2017, which is incorporated herein by reference in its entirety.

### TECHNICAL FIELD

This invention relates generally to databases.

### BACKGROUND

Review websites allow users to enter reviews for products for sale. Potential customers can browse a review website to see other customers' experiences with different products.

### BRIEF DESCRIPTION OF THE DRAWINGS

Disclosed herein are embodiments of apparatuses and methods for review management. This description includes drawings, wherein:

FIG. 1 comprises a system diagram of an overall system in accordance with several embodiments;

FIG. 2 comprises a flow diagram of a method in accordance with several embodiments;

FIG. 3 comprises a process diagram of a method in accordance with several embodiments;

FIG. 4 comprises an illustration of blocks as configured in accordance with various embodiments of these teachings;

FIG. 5 comprises an illustration of transactions configured in accordance with various embodiments of these teachings;

FIG. 6 comprises a flow diagram in accordance with various embodiments of these teachings;

FIG. 7 comprises a process diagram as configured in accordance with various embodiments of these teachings;

FIG. 8 comprises an illustration of a delivery record configured in accordance with various embodiments of these teachings; and

FIG. 9 comprises a system diagram configured in accordance with various embodiments of these teachings.

Elements in the figures are illustrated for simplicity and clarity and have not necessarily been drawn to scale. For example, the dimensions and/or relative positioning of some of the elements in the figures may be exaggerated relative to other elements to help to improve understanding of various embodiments of the present invention. Also, common but well-understood elements that are useful or necessary in a commercially feasible embodiment are often not depicted in order to facilitate a less obstructed view of these various embodiments of the present invention. Certain actions and/or steps may be described or depicted in a particular order of occurrence while those skilled in the art will understand that such specificity with respect to sequence is not actually required. The terms and expressions used herein have the ordinary technical meaning as is accorded to such terms and expressions by persons skilled in the technical field as set forth above except where different specific meanings have otherwise been set forth herein.

### DETAILED DESCRIPTION

Generally speaking, pursuant to various embodiments, systems, apparatuses and methods are provided herein for review management. In some embodiments, a system for authenticated customer retail product review management comprises a communication device configured to communicate with one or more nodes of a distributed transaction ledger over a network, wherein the distributed transaction ledger comprises digital product purchase records associated with a plurality of entities, a memory device, a user interface device, and a control circuit coupled to the communication device, the memory device, and the user interface device. The control circuit being configured to receive a private key and a public key associated with a user, index, in the memory device, transactions associated with the user in the distributed transaction ledger using at least one of the public key and the private key, determine products owned by the user based on the transactions associated with the user, display, via the user interface device, one or more products owned by the user in a customer review user interface, receive a product review for a product owned by the user via the customer review user interface, generate a product review record based on the product review, and send, via the communication device, the product review record to a distributed database as an update to the distributed database.

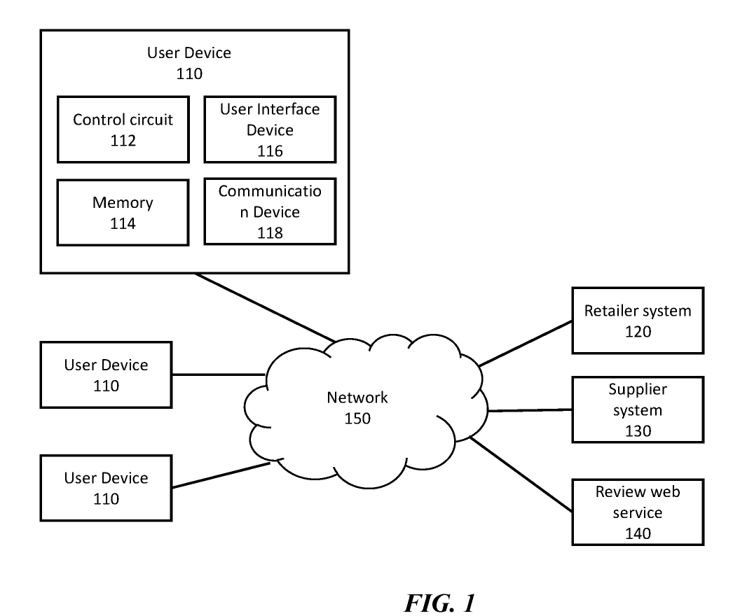

Referring now to FIG. 1, a review management system is shown. The system comprises a plurality of user devices 110, a retailer system 120, a supplier system 130, and a review web service system 140 communicating over a network 150.

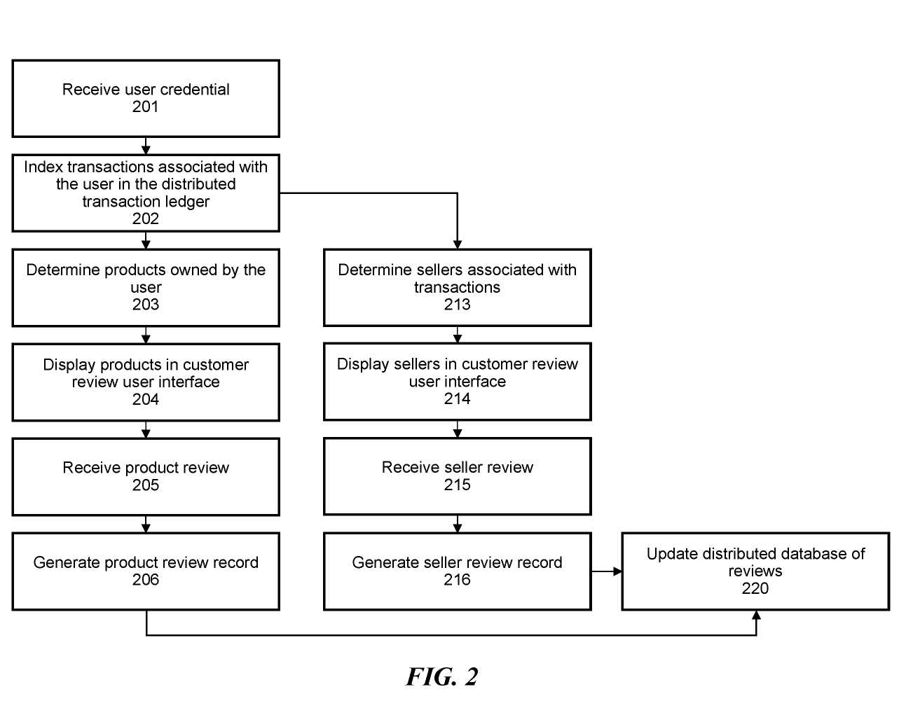

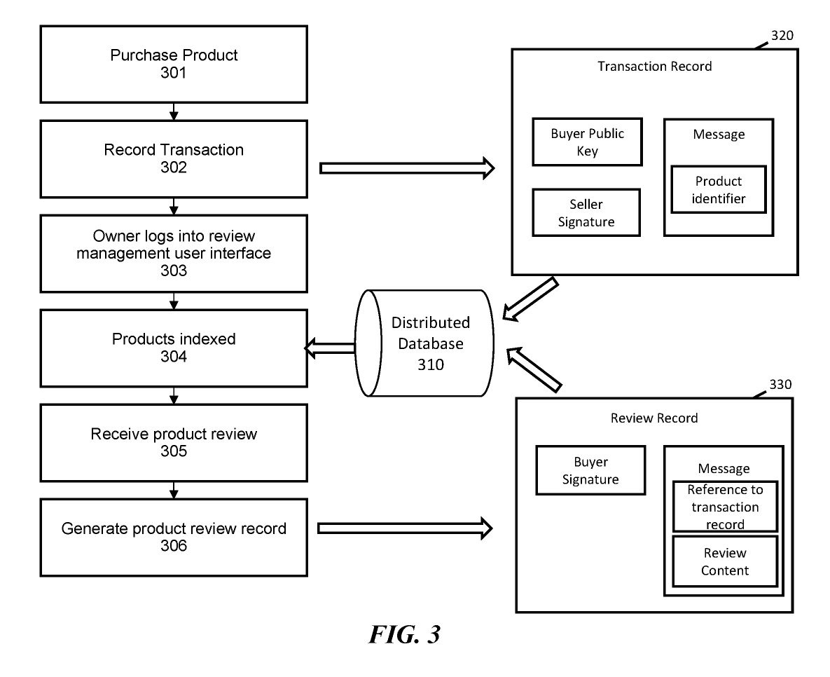

A user device 110 may comprise a device associated with a customer and/or a seller. In some embodiments, the user device 110 may comprise one or more of a computer, a mobile device, a smartphone, a tablet computer, a wearable device, a home assistance device, an Internet of Things (IoT) device, and the like. A user device 110 may comprise a control circuit 112, a user interface device 116, a memory 114, and a communication device 118. The control circuit 112 may comprise a processor, a microprocessor, a microcontroller, and the like and may be configured to execute computer readable instructions stored on a computer readable storage memory 114. The computer readable storage memory 114 may comprise volatile and/or non-volatile memory and have stored upon it a set of computer readable instructions which, when executed by the control circuit 112, causes the control circuit 112 to provide a customer review interface via the user interface device 116 based on information stored in a distributed transaction ledger comprising digital transaction records. In some embodiments, the control circuit 112 may further be configured to update a distributed database based on user submitted reviews. In some embodiments, the user device 110 may comprise a node of the distributed ledger and/or database. In some embodiments, the distributed transaction ledger and/or database may comprise one or more of a blockchain, a hyperledger, a distributed ledger, a distributed hashchain, and the like. In some embodiments, the distributed transaction ledger system may be based on tools and algorithms of the Linux Hyperledger project, the bitcoin blockchain, or other similar schemes. In some embodiments, the computer executable instructions may comprise a client software of a distributed database similar to a bitcoin wallet. In some embodiments, the memory 114 may store at least a subset of data from the distributed database of customer review and/or transaction records. In some embodiments, the control circuit 112 may be configured to perform one or more steps described with reference to FIGS. 2-3 herein.

The user interface device 116 may comprise user input/output devices such as one or more of a display screen, a touch screen, a VR display, an AR display, one or more buttons, a keypad, a microphone, a speaker, a camera, a motion sensor, an eye movement sensor, etc. Generally, the user interface device 116 may be configured to present a customer review user interface to a user and allow the user to interact with the customer review user interface to enter user reviews. In some embodiments, the communication device 118 may comprise one or more of a Wi-Fi transceiver, a mobile data transceiver, a network adapter, an Internet modem, and the like. Generally, the communication device 118 may be configured to allow the user device to communicate with one or more nodes of a distributed database storing transaction records and/or review records over a network. In some embodiments, the communication device 118 may further be configured to communicate with a point of sales (POS) system to authorize payment for a purchase and/or generate a transaction record for a purchase.

The retailer system 120 may comprise a processor-based system associated with a retailer. The retailer system 120 may comprise a control circuit and a memory. In some embodiments, the retailer system 120 may comprise one or more of a computer, a server system, an e-commerce system, a point of sales system, and the like. The control circuit of the retailer system may comprise a processor, a microprocessor, a microcontroller, and the like and may be configured to execute computer readable instructions stored on a computer readable storage memory of the retailer system. The computer readable storage memory may comprise volatile and/or non-volatile memory and have stored upon it a set of computer readable instructions which, when executed by the control circuit, causes the control circuit to process product sales and provide the transaction record to a distributed transaction ledger as an update to the transaction ledger. In some embodiments, the retailer system 120 may further be configured to function as a “miner” of a blockchain of transaction records and/or review records and gather records together to form blocks for the blockchain. In some embodiments, the retailer system 120 may comprise a node of the distributed ledger and/or database. In some embodiments, the computer executable instructions may comprise a client software of the distributed database similar to a bitcoin wallet. In some embodiments, the memory of the retailer system 120 may store at least a subset of data from the distributed database of customer review and/or transaction records. In some embodiments, the retailer system 120 may comprise a user interface device and/or a communication device. In some embodiments, the retailer system 120 may be configured to perform one or more steps described with reference to FIGS. 2-3 herein.

The supplier system 130 may comprise a system associated with a product supplier such as a manufacturer, distributor, wholesaler, etc. The supplier system 130 may comprise a control circuit and a memory. In some embodiments, the supplier system 130 may comprise one or more of a computer, a server system, an order management system, and the like. The control circuit of the supplier system 130 may comprise a processor, a microprocessor, a microcontroller, and the like and may be configured to execute computer readable instructions stored on a computer readable storage memory of the supplier system 130. The computer readable storage memory may comprise volatile and/or non-volatile memory and have stored upon it a set of computer readable instructions which, when executed by the control circuit, causes the control circuit to process sales to retailers and provide the transaction record to a distributed transaction ledger as an update to the transaction ledger. In some embodiments, the supplier system 130 may comprise a node of the distributed ledger and/or database. In some embodiments, the supplier system 130 may further be configured serve as a “miner” node of a blockchain of transaction and/or review records and gather records together to form blocks for the blockchain. In some embodiments, the computer executable instructions may comprise a client software of the distributed database similar to a bitcoin wallet. In some embodiments, the memory of the supplier system 130 may store at least a subset of data from the distributed database of customer review and/or transaction records. In some embodiments, the supplier system 130 may comprise a user interface device and/or a communication device. In some embodiments, the supplier system 130 may be configured to perform one or more steps described with reference to FIGS. 2-3 herein.

The review web service system 140 may comprise a computer, a server system, a web hosting service, and the like. The review web service system 140 may comprise a control circuit and a memory. In some embodiments, the review web service system 140 may comprise one or more of a computer, a server system, an order system, and the like. The control circuit of the review web service system 140 may comprise a processor, a microprocessor, a microcontroller, and the like and may be configured to execute computer readable instructions stored on a computer readable storage memory of the review web service system 140. The computer readable storage memory may comprise volatile and/or non-volatile memory and have stored upon it a set of computer readable instructions which, when executed by the control circuit, causes the control circuit to index reviews in a distributed database and make the review accessible to websites and/or as a public database. In some embodiments, the review web service system 140 may provide an online review user interface based on the review records in the distributed database for potential customers to browse through product and service reviews. In some embodiments, the review web service system 140 may provide the indexed reviews as a simple text or spreadsheet file that can be used by retailers, suppliers, or third party websites to display product reviews or perform market analysis. In some embodiments, the review web service system 140 may comprise a node of the distributed ledger and/or database. In some embodiments, the computer executable instructions may comprise a client software of the distributed database similar to a bitcoin wallet. In some embodiments, the memory of the review web service system 140 may store at least a subset of data from the distributed database of customer review and/or transaction records. In some embodiments, the review web service system 140 may comprise a user interface device and/or a communication device. In some embodiments, the review web service system 140 may be configured to perform one or more steps described with reference to FIGS. 2-3 herein.

The network 150 may comprise one or more of the Internet, a public network, a private network, a secured network, a virtual private network, and the like. Generally, the network 150 is configured to allow one or more of the user devices 110, the retailer system 120, and supplier system 130, and the review web service system 140 to communicate with each other to manage product and service reviews. In some embodiments, one or more of the user devices 110, the retailer system 120, supplier system 130, and the review web service system 140 may comprise nodes of a distributed database which are configured to collectively verify, update, and maintain transaction records and/or customer reviews in one or more distributed databases. In some embodiments, the distributed database may comprise one or more of a blockchain, a Hyperledger, a distributed ledger, a distributed hashchain, and the like. In some embodiments, the distributed transaction ledger system may be based on tools and algorithms of the Linux Hyperledger project, the bitcoin blockchain, or other similar schemes. In some embodiments, one or more of the user devices 110, the retailer system 120, the supplier system 130, and the review web service system 140 may be configured to generate updates to the distributed database, form blocks for the distributed database, and/or verify the validity of updates to the distributed database. In some embodiments, one or more of the user devices 110, the retailer system 120, supplier system 130, and the review web service system 140 may be configured to collectively verify that a review is submitted by a confirmed owner of the product being reviewed and ensure that the review is not altered by an unauthorized entity. In some embodiments, one or more of the user devices 110, the retailer system 120, supplier system 130, and the review web service system 140 may be configured to collectively perform one or more steps described with reference to FIGS. 2-3 herein.

Referring now to FIG. 2, a method of providing review management is shown. In some embodiments, the steps shown in FIG. 2 may be performed by a processor-based device such as one or more of a computer system, a service system, a user device, and a point of sale system. In some embodiments, the steps in FIG. 2 may be performed by one or more of the user devices 110, the retailer system 120, supplier system 130, and the review web service system 140 described with reference to FIG. 1 herein or similar devices.

In step 201, the system receives user credential. In some embodiments, the user credential may comprise a public and private key pair associated with a user. In some embodiments, the public and private keys are associated based on public-key cryptography. In some embodiments, the user credential may be entered into and/or stored at a client software of a distributed database on a user device. In some embodiments, the client software may comprise a secured software application, a desktop application, a mobile application, a web-based application, a cloud-based application, a website and the like.

In step 202, the system indexes transaction associated with the user in a distributed transaction ledger. In some embodiments, the distributed transaction ledger comprises digital product purchase records associated with a plurality of entities. In some embodiments, the distributed transaction ledger may comprise ownership records of physical and/or digital assets. In some embodiments, a physical and/or digital asset identifier may be generated by a manufacturer when the item is produced. In some embodiments, a product (asset) may be identified by a unique product identifier (e.g. VIN number, serial number) and/or a common identifier (e.g. UPC, barcode), etc. The distributed transaction ledger may be updated by the manufacturer, supplier, distributor, and/or retailer with each ownership change. When a product is sold from a retailer or a private seller to the user, the ownership record of the item may be assigned over to the user in the distributed transaction ledger. In some embodiments, the user device may be configured to process a transaction via a user interface device, send a record of the transaction to the distributed transaction ledger, and index the transaction in the memory device. For example, when a user uses digital currency transaction to purchase an item, the transaction may trigger an update to the transaction record that identified the product purchased. In another example, the buyer may provide their public key to the seller during the transaction, and the seller may generate the transaction record and ownership change using the public key. In some embodiments, ownership of items may be tracked through blockchain-based digital and/or physical asset tracking systems such as a sidechain or an altchain to the bitcoin blockchain or a Hyperledger.

In some embodiments, each transaction record may comprise a public key of the new owner and a digital signature of the seller generated using the sellers' private key. In some embodiments, the transactions associated with the user comprise transactions containing the public key or a digital signature generated using the private key of the user. In some embodiments, the transaction record may comprise a message containing transaction details such as a product identifier, a transaction date, a transaction price, a transaction type (e.g. in-store purchase, online purchase, free sample, etc.), etc. In some embodiments, the transaction record may also comprise other types of ownership changes such as returns, refunds, resells, exchanges, replacements, and the like. In some embodiments, the client software may be configured to allow a user to indicate that the item is lost, destroyed, or discarded and the transaction records may be updated to reflect that the item is now nonexistent or ownerless. In some embodiments, in step 202, the client software may look through all the transaction records in the distributed transaction ledger to identify the transactions associated with the user's credential (e.g. public key, signature, etc.) provided in step 201. In some embodiments, in step 202, the system may maintain a record of each transaction carried out through the client software and/or the user account without having to look through all the transaction records. In some embodiments, the client software may only index blocks of the distributed transaction ledger that have not been previously indexed to identify any new transactions associated with the user.

In some embodiments, the distributed transaction ledger may be locally stored on the memory device of the user device and/or accessed through a network. In some embodiments, the distributed transaction ledger may comprise one or more of a blockchain, a Hyperledger, a distributed database, a hashchain, and the like. In some embodiments, the distributed transaction ledger system may be based on tools and algorithms of the Linux Hyperledger project, the bitcoin blockchain, or other similar schemes.

In step 203, the system determines products owned by the user based on the transactions associated with the user. In some embodiments, products owned by the user may comprise products purchased by the customer and never returned, exchange, or resold by the user. In some embodiments, for each product identified in the transactions associated in the transaction ledger, the system may look at the latest transaction involving the product to determine whether the user is the last recorded owner. In some embodiments, in step 203, the system may further look at the review records in the distributed database to determine whether a review had been previously submitted for each identified product. In some embodiments, the system may only allow one review per purchase or one review per product per customer. In some embodiments, the system may separate products by their product version or firmware updates and allow customers to leave different reviews for different versions of a product. In some embodiments, the system may allow a customer to update, remove, or revise previously submitted reviews.

In step 204, the system displays products determined to be owned by the user in step 203 in a customer review user interface. In some embodiments, the distributed database client software may comprise a customer review user interface that allows customers to enter reviews. In some embodiments, the products may be displayed with product descriptions (e.g. name, image, specifications) and/or transaction details (e.g. seller, purchase date, price, etc.). The customer review user interface may comprise text boxes and/or rating inputs (e.g. star rating, score, etc.) for the customer to provide reviews to a product or a service. In some embodiments, the system would not allow users to leave reviews for products that the user never owned and/or no longer owns.

In step 205, the system receives a customer review. In some embodiments, the review may comprise text input, a score, or multiple scores associated with different characteristics of the product (e.g. quality, price, ease of use, taste, durability, etc.). In some embodiments, the system may further allow the customer to upload images, videos, and audio clips with the review. In some embodiments, images, videos, and audio clips may be stored on a server storage and the review record may comprise a pointer (e.g. URL) to the server location of the images, videos, and audio clips.

In step 206, the system generates a product review record. In some embodiments, the product review record may comprise one or more of a product identifier, a reviewer identifier, and the submitted review. In some embodiments, a product review record comprises one or more of a signature generated with the private key of the user and a reference to a transaction associated with the product in the distributed transaction ledger as proof of ownership of the product being reviewed. In some embodiments, the product review record may further comprise other transaction details such as seller, purchase date, purchase condition (e.g. refurbished, second hand, etc.), product version, product firmware version, etc. In some embodiments, the review record may be encrypted or partially encrypted.

In step 220, the system sends the product review record to a distributed database as an update to the distributed database. In some embodiments, the distributed database of reviews may comprise the distributed transaction ledger storing the digital product purchase records or a separately maintained distributed database. In some embodiments, one or more nodes of the distributed database may be configured to verify ownership of the product prior to updating the distributed database with the product review record submitted by the user. For example, the nodes may verify that the proof of ownership of the product referenced in the review record contains a valid chain of ownership. In another example, the nodes may verify that the last transaction involving the product in the distributed transaction ledger identifies the user as the current owner. In some embodiments, the verification may be performed by the distributed database client software running on one or more user devices and/or nodes. In some embodiments, nodes of the distributed database may be configured to add the product review record to a new block of the distributed database. In some embodiments, each block of the distributed database may comprise a hash of a previous block in the chain forming a blockchain. In some embodiments, the blocks of the distributed database for recorded customer reviews may be generated based on the tools and algorithms of the bitcoin blockchain system, the Linux Hyperledger project, or similar schemes.

In some embodiments, the system may further allow buyers to review sellers based on the distributed transaction ledger. In step 213, the system determines sellers associated with transactions associated with the user. In some embodiments, the sellers may comprise entities whose signature are in transaction records transferring ownership of an item to the user. In some embodiments, the sellers may comprise entities who has ownership of an item just prior to the ownership being transferred to the buyer. In some embodiments, the system may allow users to review sellers even if the purchased product is returned, exchanged, resold, etc.

In step 214, the system display sellers determined in step 213 in the customer review user interface and allow customers to enter reviews for sellers. In some embodiments, the sellers may be displayed with transaction details (e.g. purchased product (s), purchase date, price, etc.) in the customer review user interface. The customer review user interface may comprise text boxes and/or rating inputs (e.g. star rating, score, etc.) for the customer to provide reviews to a seller. In some embodiments, the system may allow one review per seller per customer and/or allow a review for each transaction between a seller and a buyer.

In step 215, the system receives a review. In some embodiments, the review may comprise text input, a score, or multiple scores associated with different characteristics of the seller (e.g. customer service, responsiveness, shipping time, etc.). In some embodiments, the system may further allow the customer to upload images, videos, and audio clips with the review. In some embodiments, images, videos, and audio clips may be stored on a networked storage and the review record may comprise a pointer (e.g. URL) to the network location of the images, videos, and audio clips.

In step 216, the system generates a seller review record. In some embodiments, the seller review record may comprise one or more of a seller identifier, a user identifier, and a submitted review. In some embodiments, a seller review record comprises one or more of a signature generated with the private key of the user and a reference to a transaction associated with the seller in the distributed transaction ledger as proof of being a legitimate customer of the seller being reviewed. In some embodiments, the seller review record may further comprise other transaction details such as item identifier, purchase date, purchase condition (e.g. refurbished, second hand, etc.), product version, product firmware version, etc.

In step 220, the system sends the seller review record to a distributed database as an update to the distributed database. In some embodiments, the distributed database comprises the distributed transaction ledger storing the digital product purchase records or a separately maintained distributed database. In some embodiments, the product and sellers reviews may be stored in the same or different distributed databases. In some embodiments, one or more nodes of the distributed database may be configured to verify that the user is a legitimate customer prior to updating the distributed database with the seller review record submitted by the user. For example, the nodes may verify that the transaction record referenced in the review record identifies the correct buyers and sellers. In some embodiments, the verification may be performed by the distributed database client software running on one or more user devices and/or nodes. In some embodiments, nodes of the distributed database may be configured to add the seller review record to a new block of the distributed database. In some embodiments, each block of the distributed database may comprise a hash of a previous block in the chain forming a blockchain. In some embodiments, the blocks of the distribute reviews database may be generated based on the tools and algorithms of the bitcoin blockchain system, the Linux Hyperledger project, or similar schemes.

In some embodiments, the customer review user interface may further be configured to display previously submitted product and/or seller reviews. In some embodiments, the system may allow the user to submit updates and/or remove previously submitted reviews. In some embodiments, updates and removal of reviews may comprise a new update to the distributed database of reviews. For example, the system may be configured to receive an updated review for the product via the customer review user interface, generate an updated product review record based on the updated review, and send the updated product review record to the distributed database as an update to the distributed database In some embodiments, an updated review record and/or a review removal record may comprise a reference to the previous review. In some embodiments, the nodes may also verify the ownership of product prior to updating the distributed database with the updated review and/or review removal. In some embodiments, the system may enforce select rules regarding review updates and removals. For example, the system may allow a review to be revised any time by the author, when the author still owns the revised item, or when there is a qualifying update event (e.g. firmware update, communication with customer service, warranty service, etc.)

In some embodiments, sellers and/or manufacturers may be permitted to submit responses to customer reviews. In some embodiments, the review response records may comprise the responder's signature and a message that comprises one or more of a reference the customer review being commented on, the transaction record associated with the customer review, and a response content. In some embodiments, a client software and/or nodes of the distributed database may be configured to verify that the responder is a manufacturer and/or seller associated with the reviewed being responded to using the transaction record and/or the review record.

With the steps shown in FIG. 2, a plurality of nodes are configured to maintain and update a review database that verifies reviewers as legitimate owners of product and/or customers of sellers and is secured against unauthorized tampering. Reviews of products sold through different channels may also be maintained and managed through a unified and decentralized distributed database independent of any particular retailer, supplier, or third party. In some embodiments, the distributed database may be configured to be indexed by a web service that converts the distributed database to web-accessible product reviews. The web-accessible product reviews may then be used by any seller, promoter, or informational web sites.

In some embodiments, product and seller reviews may be added to a centralized database instead of a distributed database. For example, a client software and/or a central server may verify the user's ownership of a product and/or status as a customer using a distributed transaction ledger as described with reference to steps 201-205 and steps 213-215. The submitted reviews are then uploaded to a server and/or a conventional database for storage and maintenance. In some embodiments, the centralized database may perform the functions of the review web service system 140 described with reference to FIG. 1 and make the review data accessible to customers and/or other websites.

Referring now to FIG. 3, a process of providing review management is shown. In some embodiments, the steps shown in FIG. 3 may be performed by a processor-based device such as one or more of a computer system, a service system, a user device, and a point of sale system. In some embodiments, the steps in FIG. 3 may be performed by one or more of the user devices 110, the retailer system 120, the supplier system 130, and the review web service system 140 described with reference to FIG. 1 herein or similar devices.

In step 301, a customer purchases a product. In some embodiments, the purchase may comprise an in-store purchase, an online purchase, a retail sale, a private sale, a second hand sale, and the like. In step 302, the transaction is recorded in a transaction record 320. In some embodiments, the transaction record 320 may be generated by the seller or the buyers' distributed database client software (e.g. bitcoin wallet). The transaction record 320 comprises a buyer's public key, a seller signature that signs the message in the transaction record. In some embodiments, the message may comprise the product identifier identifying the product(s) purchased in the transaction to transfer ownership of the product to the buyer. In some embodiments, a product may be identified by a unique product identifier (e.g. registration number, VIN number, serial number) and/or a common identifier (e.g. UPC, barcode), etc. In some embodiments, the message may comprise a reference to one or more previous transaction records associated with the product (e.g. from manufacturer to distributor, from distributor to sellers, etc.) as a proof of the seller's original ownership of the product. In some embodiments, the message of the transaction record 320 may comprise other transaction details such as a seller identifier, a transaction date, a transaction price, a transaction type (e.g. in-store purchase, online purchase, free sample, etc.). In some embodiments, at least a portion of the message may be unencrypted. In some embodiments, at least a portion of the message may be encrypted with the public key of the seller or the buyer. In some embodiments, the transaction record 320 may record other types of ownership changes such as returns, refunds, resells, exchanges, replacements, and the like. For example, a return transaction record may comprise the public key of the original seller and be signed by the buyer's private key to transfer ownership of the product back to the seller. Transaction records between different buyers and sellers are then sent to nodes of the distributed database 310. In some embodiments, a client software and/or one or more nodes of the distributed database 310 may check the transaction record to verify that the transaction complies with the rules of the distributed database 310. For example, the nodes may check the product identifier and/or the ownership chain in the message of the transaction record 320 to verify that the product has not be transferred to multiple entities (e.g. double spent) based on the existing transaction records in the distributed database 310. In some embodiments, the message may comprise the transfer of a review token for the product and/or a review token of the seller that the buyer can use to submit reviews for the product and/or sellers similar to a digital currency. In some embodiments, transaction records are time stamped and aggregated into hashed blocks by “miner” nodes of the distributed database 310 and added to the distributed database 310. In some embodiments, the enforcement of physical and/or digital assets transfer rules and may be performed via community consensus algorithm of a blockchain.

In step 304, transactions in the distributed database 310 are indexed for a user. In some embodiments, the system may index all transactions associated with a user (e.g. includes the user's public key, signed by user's signature, etc.). In some embodiments, the system may further identify products owned by the user based on the indexed transaction. In step 305, the system receives a product review for an item determined to be owned by the user. In step 306, the system generates a review record 330 for the received review. In some embodiments, steps 304-306 may be performed by a client software of the distributed database 310 on a user device. In some embodiments, steps 304-306 may comprise steps 202-206 described with reference to FIG. 2 herein or similar steps.

The review record 330 comprises a message signed by the buyer's private key. The message of a review record 330 may comprise a reference to a transaction record showing the user's ownership of the product and the content of the review. In some embodiments, the review record 330 may further comprise a product or seller identifier identifying the product or seller being reviewed. In some embodiments, the message of the review record 330 may comprise other transaction details such as a seller identifier, a transaction date, a transaction price, a transaction type (e.g. in-store purchase, online purchase, free sample, etc.). In some embodiments, at least a portion of the message may be unencrypted, encrypted with the public key of the buyer, or encrypted with the public key of a review web service. In some embodiments, a review record 330 may record updated reviews or review removals. In some embodiments, an updated review may comprise a reference to the original review record and/or the transaction record associated with the product and/or seller being reviewed. In some embodiments, if a post-purchase action (e.g. exchange, repair, customer service ticket, firmware update, etc.) is associated with the update review, the updated review may further references the post-purchase action record in the review. Reviews submitted by customers are then sent to nodes of the distributed database 310. In some embodiments, a client software and/or one or more nodes of the distributed database 310 may verify the transaction record to verify that review record complies with the rules of the distributed database. For example, the nodes may check the transaction record referenced in the message of the transaction record to verify that the user is a current owner of the product and the product has not been transferred to another entity (e.g. resold, returned, etc.) based on the existing transaction records in the distributed database 310. In some embodiments, the nodes may further verify whether the user has already left a review for the product and/or transaction. In some embodiments, review records 330 may be timestamped and aggregated into hashed blocks by “miner” nodes of the distributed database 310 and added to the distributed database 310.

In some embodiments, sellers and/or manufacturers may be permitted to submit responses to customer reviews. In some embodiments, the review response records may comprise the responder's signature and a message that comprises one or more of a reference the custom review being commented on, the transaction record associated with the customer review, and the response content. In some embodiments, a client software and/or nodes of the distributed database 310 may be configured to verify that the responder is a manufacturer and/or a seller associated with the product or transaction being reviewed in the customer review, using the transaction record 320 and/or the review record 330.

In some embodiments, the distributed database 310 may be indexed by a review web service configured to convert the distributed database to web-accessible reviews. For example, the web service may aggregate reviews of a product or a seller from a plurality of users. In some embodiments, the web service may separate reviews for different versions (hardware or software) of a product based on transaction records associated with each review. In some embodiments, the web service may be configured to replace, update, or remove reviews based on review records of a product associated with the same user in the distributed database. For example, if an updated review has been submitted after an initial review, the web service may modify or replace the original review based on the update. In some embodiments, the review web service may generate a user interface for browsing reviews and/or provide the indexed data as publically accessible data over a network such as the Internet.

In some embodiments, the systems and methods described herein support storing and sharing product reviews in blockchain databases. Customer product reviews may be recorded in updates to a blockchain comprising a distributed transaction ledger that may be encrypted with public/private key cryptography. In some embodiments, the distributed database allows customers to find unique reviews specific to the product or a similar product and streamlines the process of viewing other customer's reviews. In some embodiments, the distributed database provides a secure system for storing reviews such that the reviews cannot be removed from the database once added.

In some embodiments, the systems and methods described herein verify customer reviews by ensuring that the customer is real and has actually purchased the product being reviewed. When a customer purchases and receives a product, the customer may also set their preferences to warn if a specified “star” level is exceeded (e.g. 3 stars or better). The customer may then submit a review to a blockchain via a distributed review system. In some embodiments, the review site may be independent of sales source and be retailer agnostic. In some embodiments, reviews may be filtered or sorted to show only verified customers. In some embodiments, reviews may be recorded in the public portion of the blockchain records. In some embodiments, the customer may configure how much of their information to share with the public (e.g. first name, last initial, region, state, other items purchased/reviewed, etc.). In some embodiments, an alert system may be configured to notify registered customers of product recalls/issues. In some embodiments, the system may allow a manufacturer to change the priority of/or remove bad reviews directed to version updates (e.g. version 2.0 firmware updates fixed issues in version 1.0). In some embodiments, the system may provide information for the manufacturer to send a replacement product to a customer in response to a bad review. In some embodiments, the system may incorporate delivery metrics which may be used with an aggregate delivery payment system (e.g. better delivery times may provide higher delivery bonuses).

In some embodiments, retailers and manufacturers may participate in a distributed ledger/blockchain system with a global review web site. When a customer purchases an item, a block is created with retailer receipt metadata including product serial number and added to the customer's wallet and indexed. At same time a subsequent block may be created for manufacturer product registration. In some embodiments, these blocks contain the customer private key signature and a public key, and the customer's private key allows the current owner to review both the product and the retailer. In some embodiments, reviews may be indexed by a global review web Site and made available to the public. In some embodiments, only customers that purchased/own the products can make reviews or add subsequent reviews which are added to the blockchain. The global review site may index all product reviews contained in the blockchain and present only reviews by product purchasers/owners. Reviews may be publically accessible from the global review web site which provides indexed reviews from the blockchain for any participating manufacturer products ensuring the reviews are only from customers that purchased and/or own the product. In some embodiments, customers can sell a product and the chain of title moves to the new owner who can now add reviews for that product. In some embodiments, if the product is recycled or destroyed, no further reviews may be created for that serial numbered item.

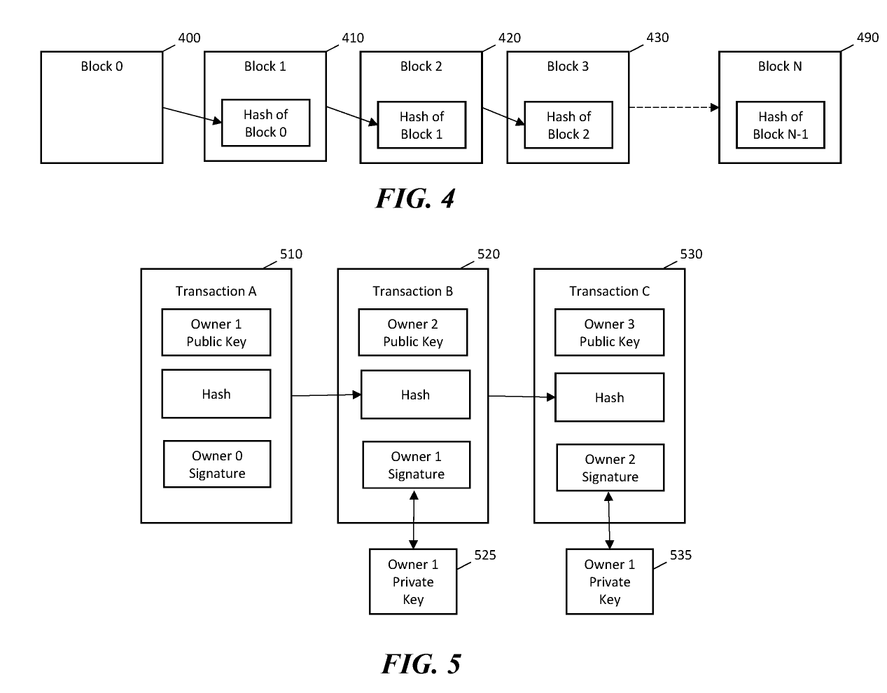

Descriptions of some embodiments of blockchain technology are provided with reference to FIG. 4-9 herein. In some embodiments of the invention described above, blockchain technology may be utilized to record peer-to-peer digital asset transfers, peer-to-peer user authentication, and peer-to-peer messaging. One or more of a central computer system, a POS system, and user device may comprise a node in a distributed blockchain system storing the blockchain record. Updates to the blockchain may comprise a transaction records, peer-to-peer messages, and/or a user profile information, and one or more nodes on the system may be configured to incorporate one or more updates into blocks to add to the distributed database.

Distributed database and shared ledger database generally refer to methods of peer-to-peer record keeping and authentication in which records are kept at multiple nodes in the peer-to-peer network instead of kept at a trusted party. A blockchain may generally refer to a distributed database that maintains a growing list of records in which each block contains a hash of some or all previous records in the chain to secure the record from tampering and unauthorized revision. A hash generally refers to a derivation of original data. In some embodiments, the hash in a block of a blockchain may comprise a cryptographic hash that is difficult to reverse and/or a hash table. Blocks in a blockchain may further be secured by a system involving one or more of a distributed timestamp server, cryptography, public/private key authentication and encryption, proof standard (e.g. proof-of-work, proof-of-stake, proof-of-space), and/or other security, consensus, and incentive features. In some embodiments, a block in a blockchain may comprise one or more of a data hash of the previous block, a timestamp, a cryptographic nonce, a proof standard, and a data descriptor to support the security and/or incentive features of the system.

In some embodiments, a blockchain system comprises a distributed timestamp server comprising a plurality of nodes configured to generate computational proof of record integrity and the chronological order of its use for content, trade, and/or as a currency of exchange through a peer-to-peer network. In some embodiments, when a blockchain is updated, a node in the distributed timestamp server system takes a hash of a block of items to be timestamped and broadcasts the hash to other nodes on the peer-to-peer network. The timestamp in the block serves to prove that the data existed at the time in order to get into the hash. In some embodiments, each block includes the previous timestamp in its hash, forming a chain, with each additional block reinforcing the ones before it. In some embodiments, the network of timestamp server nodes performs the following steps to add a block to a chain: 1) new activities are broadcasted to all nodes, 2) each node collects new activities into a block, 3) each node works on finding a difficult proof-of-work for its block, 4) when a node finds a proof-of-work, it broadcasts the block to all nodes, 5) nodes accept the block only if activities are authorized, and 6) nodes express their acceptance of the block by working on creating the next block in the chain, using the hash of the accepted block as the previous hash. In some embodiments, nodes may be configured to consider the longest chain to be the correct one and work on extending it. A digital currency implemented on a blockchain system is described by Satoshi Nakamoto in “Bitcoin: A Peer-to-Peer Electronic Cash System” (http://bitcoin.org/bitcoin. pdf), the entirety of which is incorporated herein by reference.

Now referring to FIG. 4, an illustration of a blockchain according to some embodiments is shown. In some embodiments, a blockchain comprises a hash chain or a hash tree in which each block added in the chain contains a hash of the previous block. In FIG. 4, block 0 400 represents a genesis block of the chain. Block 1 410 contains a hash of block 0 400, block 2 420 contains a hash of block 1 410, block 3 430 contains a hash of block 2 420, and so forth. Continuing down the chain, block N contains a hash of block N−1. In some embodiments, the hash may comprise the header of each block. Once a chain is formed, modifying or tampering with a block in the chain would cause detectable disparities between the blocks. For example, if block 1 is modified after being formed, block 1 would no longer match the hash of block 1 in block 2. If the hash of block 1 in block 2 is also modified in an attempt to cover up the change in block 1, block 2 would not then match with the hash of block 2 in block 3. In some embodiments, a proof standard (e.g. proof-of-work, proof-of-stake, proof-of-space, etc.) may be required by the system when a block is formed to increase the cost of generating or changing a block that could be authenticated by the consensus rules of the distributed system, making the tampering of records stored in a blockchain computationally costly and essentially impractical. In some embodiments, a blockchain may comprise a hash chain stored on multiple nodes as a distributed database and/or a shared ledger, such that modifications to any one copy of the chain would be detectable when the system attempts to achieve consensus prior to adding a new block to the chain. In some embodiments, a block may generally contain any type of data and record. In some embodiments, each block may comprise a plurality of transaction and/or activity records.

In some embodiments, blocks may contain rules and data for authorizing different types of actions and/or parties who can take action. In some embodiments, transaction and block forming rules may be part of the software algorithm on each node. When a new block is being formed, any node on the system can use the prior records in the blockchain to verify whether the requested action is authorized. For example, a block may contain a public key of an owner of an asset that allows the owner to show possession and/or transfer the asset using a private key. Nodes may verify that the owner is in possession of the asset and/or is authorized to transfer the asset based on prior transaction records when a block containing the transaction is being formed and/or verified. In some embodiments, rules themselves may be stored in the blockchain such that the rules are also resistant to tampering once created and hashed into a block. In some embodiments, the blockchain system may further include incentive features for nodes that provide resources to form blocks for the chain. For example, in the Bitcoin system, “miners' are nodes that compete to provide proof-of-work to form a new block, and the first successful miner of a new block earns Bitcoin currency in return.

Now referring to FIG. 5, an illustration of blockchain based transactions according to some embodiments is shown. In some embodiments, the blockchain illustrated in FIG. 5 comprises a hash chain protected by private/public key encryption. Transaction A 510 represents a transaction recorded in a block of a blockchain showing that owner 1 (recipient) obtained an asset from owner 0 (sender). Transaction A 510 contains owner's 1 public key and owner 0's signature for the transaction and a hash of a previous block. When owner 1 transfers the asset to owner 2, a block containing transaction B 520 is formed. The record of transaction B 520 comprises the public key of owner 2 (recipient), a hash of the previous block, and owner 1's signature for the transaction that is signed with the owner 1's private key 525 and verified using owner 1's public key in transaction A 510. When owner 2 transfers the asset to owner 3, a block containing transaction C 530 is formed. The record of transaction C 530 comprises the public key of owner 3 (recipient), a hash of the previous block, and owner 2's signature for the transaction that is signed by owner 2's private key 535 and verified using owner 2's public key from transaction B 220. In some embodiments, when each transaction record is created, the system may check previous transaction records and the current owner's private and public key signature to determine whether the transaction is valid. In some embodiments, transactions are be broadcasted in the peer-to-peer network and each node on the system may verify that the transaction is valid prior to adding the block containing the transaction to their copy of the blockchain. In some embodiments, nodes in the system may look for the longest chain in the system to determine the most up-to-date transaction record to prevent the current owner from double spending the asset. The transactions in FIG. 5 are shown as an example only. In some embodiments, a blockchain record and/or the software algorithm may comprise any type of rules that regulate who and how the chain may be extended. In some embodiments, the rules in a blockchain may comprise clauses of a smart contract that is enforced by the peer-to-peer network.

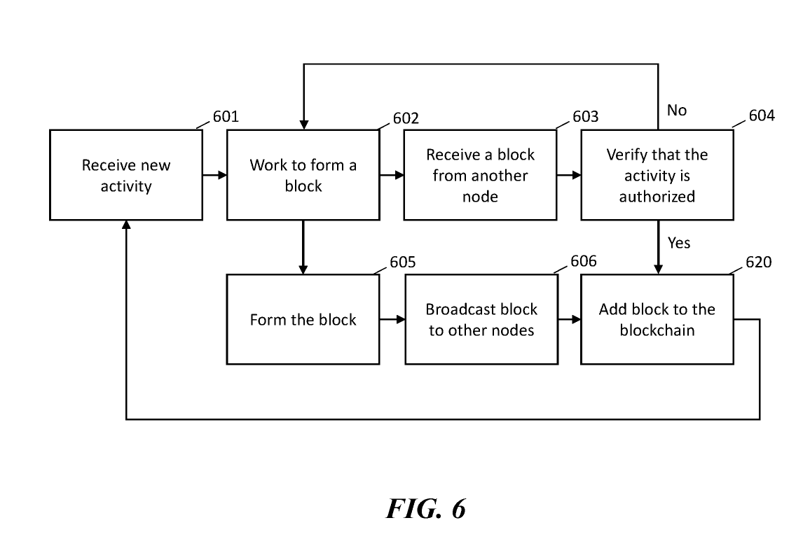

Now referring to FIG. 6, a flow diagram according to some embodiments is shown. In some embodiments, the steps shown in FIG. 6 may be performed by a processor-based device, such as a computer system, a server, a distributed server, a timestamp server, a blockchain node, and the like. In some embodiments, the steps in FIG. 6 may be performed by one or more of the nodes in a system using blockchain for record keeping.

In step 601, a node receives a new activity. The new activity may comprise an update to the record being kept in the form of a blockchain. In some embodiments, for blockchain supported digital or physical asset record keeping, the new activity may comprise an asset transaction. In some embodiments, the new activity may be broadcasted to a plurality of nodes on the network prior to step 601. In step 602, the node works to form a block to update the blockchain. In some embodiments, a block may comprise a plurality of activities or updates and a hash of one or more previous block in the blockchain. In some embodiments, the system may comprise consensus rules for individual transactions and/or blocks and the node may work to form a block that conforms to the consensus rules of the system. In some embodiments, the consensus rules may be specified in the software program running on the node. For example, a node may be required to provide a proof standard (e.g. proof of work, proof of stake, etc.) which requires the node to solve a difficult mathematical problem for form a nonce in order to form a block. In some embodiments, the node may be configured to verify that the activity is authorized prior to working to form the block. In some embodiments, whether the activity is authorized may be determined based on records in the earlier blocks of the blockchain itself.

After step 602, if the node successfully forms a block in step 605 prior to receiving a block from another node, the node broadcasts the block to other nodes over the network in step 606. In some embodiments, in a system with incentive features, the first node to form a block may be permitted to add incentive payment to itself in the newly formed block. In step 620, the node then adds the block to its copy of the blockchain. In the event that the node receives a block formed by another node in step 603 prior to being able to form the block, the node works to verify that the activity recorded in the received block is authorized in step 604. In some embodiments, the node may further check the new block against system consensus rules for blocks and activities to verify whether the block is properly formed. If the new block is not authorized, the node may reject the block update and return to step 602 to continue to work to form the block. If the new block is verified by the node, the node may express its approval by adding the received block to its copy of the blockchain in step 620. After a block is added, the node then returns to step 601 to form the next block using the newly extended blockchain for the hash in the new block.

In some embodiments, in the event one or more blocks having the same block number is received after step 620, the node may verify the later arriving blocks and temporarily store these block if they pass verification. When a subsequent block is received from another node, the node may then use the subsequent block to determine which of the plurality of received blocks is the correct/consensus block for the blockchain system on the distributed database and update its copy of the blockchain accordingly. In some embodiments, if a node goes offline for a time period, the node may retrieve the longest chain in the distributed system, verify each new block added since it has been offline, and update its local copy of the blockchain prior to proceeding to step 601.

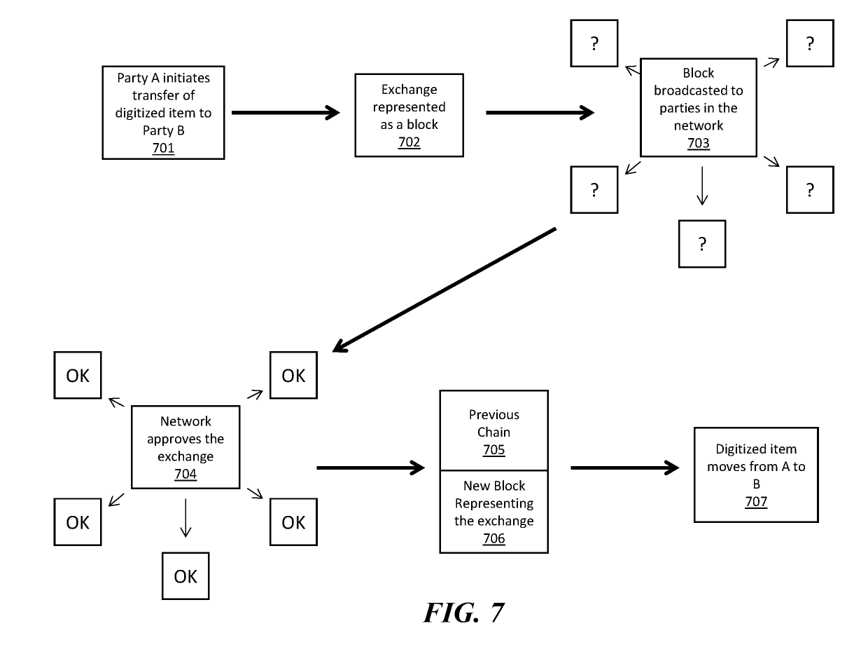

Now referring to FIG. 7, a process diagram a blockchain update according to some implementations in shown. In step 701, party A initiates the transfer of a digitized item to party B. In some embodiments, the digitized item may comprise a digital currency, a digital asset, a document, rights to a physical asset, etc. In some embodiments, Party A may prove that he has possession of the digitized item by signing the transaction with a private key that may be verified with a public key in the previous transaction of the digitized item. In step 702, the exchange initiated in step 701 is represented as a block. In some embodiments, the transaction may be compared with transaction records in the longest chain in the distributed system to verify part A's ownership. In some embodiments, a plurality of nodes in the network may compete to form the block containing the transaction record. In some embodiments, nodes may be required to satisfy proof-of-work by solving a difficult mathematical problem to form the block. In some embodiments, other methods of proof such as proof-of-stake, proof-of-space, etc. may be used in the system. In some embodiments, the node that is first to form the block may earn a reward for the task as incentive. For example, in the Bitcoin system, the first node to provide prove of work to for block the may earn a Bitcoin. In some embodiments, a block may comprise one or more transactions between different parties that are broadcasted to the nodes. In step 703, the block is broadcasted to parties in the network. In step 704, nodes in the network approve the exchange by examining the block that contains the exchange. In some embodiments, the nodes may check the solution provided as proof-of-work to approve the block. In some embodiments, the nodes may check the transaction against the transaction record in the longest blockchain in the system to verify that the transaction is valid (e.g. party A is in possession of the asset he/she s seeks to transfer). In some embodiments, a block may be approved with consensus of the nodes in the network. After a block is approved, the new block 706 representing the exchange is added to the existing chain 705 comprising blocks that chronologically precede the new block 706. The new block 706 may contain the transaction(s) and a hash of one or more blocks in the existing chain 705. In some embodiments, each node may then update their copy of the blockchain with the new block and continue to work on extending the chain with additional transactions. In step 707, when the chain is updated with the new block, the digitized item is moved from party A to party B.

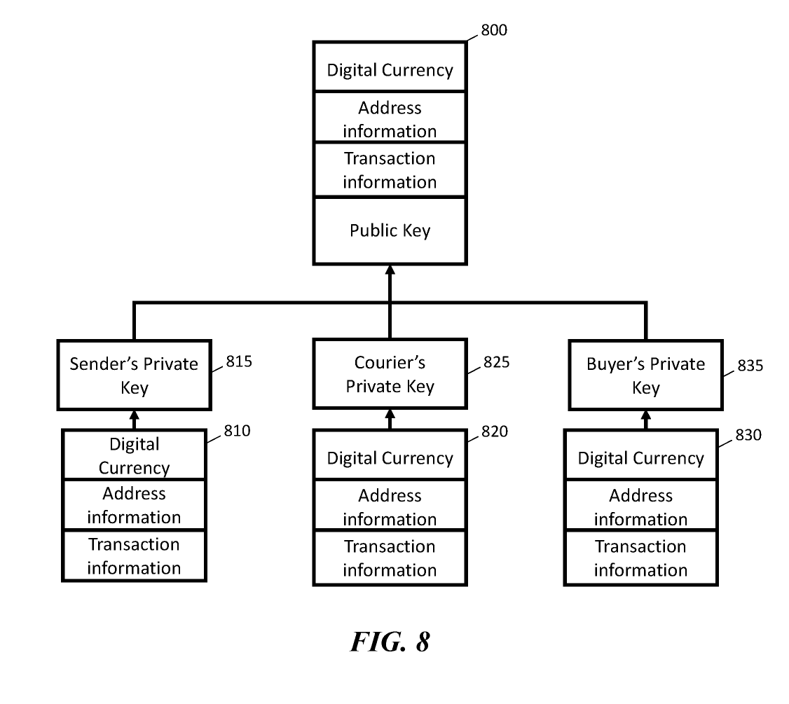

Now referring to FIG. 8, a diagram of a blockchain according to some embodiments in shown. FIG. 8 comprises an example of an implementation of a blockchain system for delivery service record keeping. The delivery record 800 comprises digital currency information, address information, transaction information, and a public key associated with one or more of a sender, a courier, and a buyer. In some embodiments, nodes associated the sender, the courier, and the buyer may each store a copy of the delivery record 810, 820, and 830 respectively. In some embodiments, the delivery record 800 comprises a public key that allows the sender, the courier, and/or the buyer to view and/or update the delivery record 800 using their private keys 815, 825, and the 835 respectively. For example, when a package is transferred from a sender to the courier, the sender may use the sender's private key 815 to authorize the transfer of a digital asset representing the physical asset from the sender to the courier and update the delivery record with the new transaction. In some embodiments, the transfer from the seller to the courier may require signatures from both the sender and the courier using their respective private keys. The new transaction may be broadcasted and verified by the sender, the courier, the buyer, and/or other nodes on the system before being added to the distributed delivery record blockchain. When the package is transferred from the courier to the buyer, the courier may use the courier's private key 825 to authorize the transfer of the digital asset representing the physical asset from the courier to the buyer and update the delivery record with the new transaction. In some embodiments, the transfer from the courier to the buyer may require signatures from both the courier and the buyer using their respective private keys. The new transaction may be broadcasted and verified by the sender, the courier, the buyer, and/or other nodes on the system before being added to the distributed delivery record blockchain.

With the scheme shown in FIG. 8, the delivery record may be updated by one or more of the sender, courier, and the buyer to form a record of the transaction without a trusted third party while preventing unauthorized modifications to the record. In some embodiments, the blockchain based transactions may further function to include transfers of digital currency with the completion of the transfer of a physical asset. With the distributed database and peer-to-peer verification of a blockchain system, the sender, the courier, and the buyer can each have confidence in the authenticity and accuracy of the delivery record stored in the form of a blockchain.

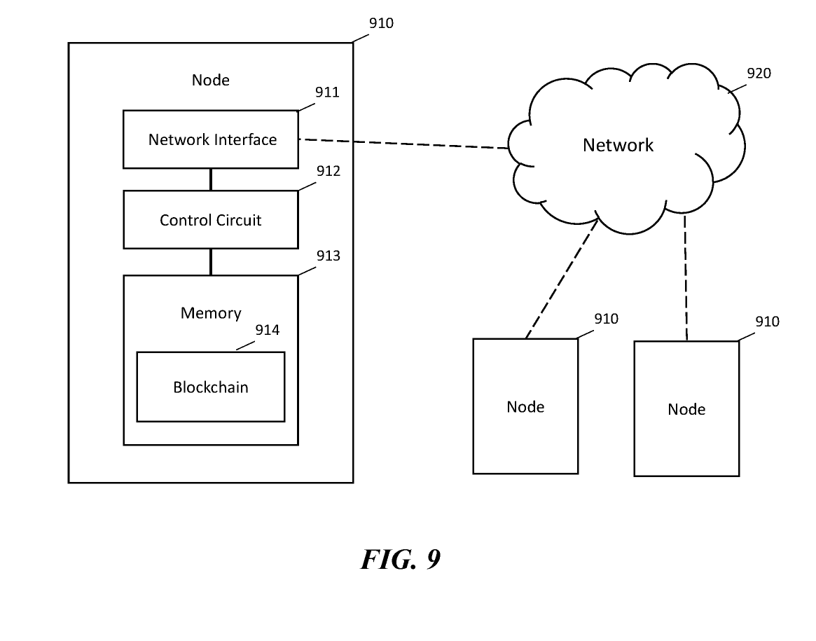

Now referring to FIG. 9, a system according to some embodiments is shown. A distributed blockchain system comprises a plurality of nodes 910 communicating over a network 920. In some embodiments, the nodes 910 may comprise a distributed blockchain server and/or a distributed timestamp server. In some embodiments, one or more nodes 910 may comprise or be similar to a “miner” device on the Bitcoin network. Each node 910 in the system comprises a network interface 911, a control circuit 912, and a memory 913.

The control circuit 912 may comprise a processor, a microprocessor, and the like and may be configured to execute computer readable instructions stored on a computer readable storage memory 913. The computer readable storage memory may comprise volatile and/or non-volatile memory and have stored upon it a set of computer readable instructions which, when executed by the control circuit 912, causes the node 910 update the blockchain 914 stored in the memory 913 based on communications with other nodes 910 over the network 920. In some embodiments, the control circuit 912 may further be configured to extend the blockchain 914 by processing updates to form new blocks for the blockchain 914. Generally, each node may store a version of the blockchain 914, and together, may form a distributed database. In some embodiments, each node 910 may be configured to perform one or more steps described with reference to FIGS. 6-7 herein.

The network interface 911 may comprise one or more network devices configured to allow the control circuit to receive and transmit information via the network 920. In some embodiments, the network interface 911 may comprise one or more of a network adapter, a modem, a router, a data port, a transceiver, and the like. The network 920 may comprise a communication network configured to allow one or more nodes 910 to exchange data. In some embodiments, the network 920 may comprise one or more of the Internet, a local area network, a private network, a virtual private network, a home network, a wired network, a wireless network, and the like. In some embodiments, the system does not include a central server and/or a trusted third party system. Each node in the system may enter and leave the network at any time.

With the system and processes shown in, once a block is formed, the block cannot be changed without redoing the work to satisfy census rules thereby securing the block from tampering. A malicious attacker would need to provide a proof standard for each block subsequent to the one he/she seeks to modify, race all other nodes, and overtake the majority of the system to affect change to an earlier record in the blockchain.

In some embodiments, blockchain may be used to support a payment system based on cryptographic proof instead of trust, allowing any two willing parties to transact directly with each other without the need for a trusted third party. Bitcoin is an example of a blockchain backed currency. A blockchain system uses a peer-to-peer distributed timestamp server to generate computational proof of the chronological order of transactions. Generally, a blockchain system is secure as long as honest nodes collectively control more processing power than any cooperating group of attacker nodes. With a blockchain, the transaction records are computationally impractical to reverse. As such, sellers are protected from fraud and buyers are protected by the routine escrow mechanism.

In some embodiments, a blockchain may use to secure digital documents such as digital cash, intellectual property, private financial data, chain of title to one or more rights, real property, digital wallet, digital representation of rights including, for example, a license to intellectual property, digital representation of a contractual relationship, medical records, security clearance rights, background check information, passwords, access control information for physical and/or virtual space, and combinations of one of more of the foregoing that allows online interactions directly between two parties without going through an intermediary. With a blockchain, a trusted third party is not required to prevent fraud. In some embodiments, a blockchain may include peer-to-peer network timestamped records of actions such as accessing documents, changing documents, copying documents, saving documents, moving documents, or other activities through which the digital content is used for its content, as an item for trade, or as an item for remuneration by hashing them into an ongoing chain of hash-based proof-of-work to form a record that cannot be changed in accord with that timestamp without redoing the proof-of-work.

In some embodiments, in the peer-to-peer network, the longest chain proves the sequence of events witnessed, proves that it came from the largest pool of processing power, and that the integrity of the document has been maintained. In some embodiments, the network for supporting blockchain based record keeping requires minimal structure. In some embodiments, messages for updating the record are broadcast on a best-effort basis. Nodes can leave and rejoin the network at will and may be configured to accept the longest proof-of-work chain as proof of what happened while they were away.

In some embodiments, a blockchain based system allows content use, content exchange, and the use of content for remuneration based on cryptographic proof instead of trust, allowing any two willing parties to employ the content without the need to trust each other and without the need for a trusted third party. In some embodiments, a blockchain may be used to ensure that a digital document was not altered after a given timestamp, that alterations made can be followed to a traceable point of origin, that only people with authorized keys can access the document, that the document itself is the original and cannot be duplicated, that where duplication is allowed and the integrity of the copy is maintained along with the original, that the document creator was authorized to create the document, and/or that the document holder was authorized to transfer, alter, or otherwise act on the document.

As used herein, in some embodiments, the term blockchain may refer to one or more of a hash chain, a hash tree, a distributed database, and a distributed ledger. In some embodiments, blockchain may further refer to systems that use one or more of cryptography, private/public key encryption, proof standard, distributed timestamp server, and inventive schemes to regulate how new blocks may be added to the chain. In some embodiments, blockchain may refer to the technology that underlies the Bitcoin system, a “sidechain” that uses the Bitcoin system for authentication and/or verification, or an alternative blockchain (“altchain”) that is based on bitcoin concept and/or code but are generally independent of the Bitcoin system.

Descriptions of embodiments of blockchain technology are provided herein as illustrations and examples only. The concepts of the blockchain system may be variously modified and adapted for different applications.

In some embodiments, a system for authenticated customer retail product review management comprises a communication device configured to communicate with one or more nodes of a distributed transaction ledger over a network, wherein the distributed transaction ledger comprises digital product purchase records associated with a plurality of entities, a memory device, a user interface device, and a control circuit coupled to the communication device, the memory device, and the user interface device. The control circuit being configured to receive a private key and a public key associated with a user, index, in the memory device, transactions associated with the user in the distributed transaction ledger using at least one of the public key and the private key, determine products owned by the user based on the transactions associated with the user, display, via the user interface device, one or more products owned by the user in a customer review user interface, receive a product review for a product owned by the user via the customer review user interface, generate a product review record based on the product review, and send, via the communication device, the product review record to a distributed database as an update to the distributed database.

In one embodiment, a method for authenticated review management comprises receiving a private key and a public key associated with a user, index, with a control circuit and in a memory device, transactions associated with the user in a distributed transaction ledger using at least one of the public key and the private key, wherein the distributed transaction ledger is accessed via a communication device configured to communicate with one or more nodes of the distributed transaction ledger over a network and wherein the distributed transaction ledger comprises digital product purchase records associated with a plurality of entities, determining, with the control circuit, products owned by the user based on the transactions associated with the user, displaying, via a user interface device, one or more products owned by the user in a customer review user interface, receiving a product review for a product owned by the user via the customer review user interface, generating a product review record based on the product review, and sending, via the communication device, the product review record to a distributed database as an update to the distributed database.

In one embodiment, an apparatus for authenticated review management comprises a non-transitory storage medium storing a set of computer readable instructions, and a control circuit configured to execute the set of computer readable instructions which causes to the control circuit to: receive a private key and a public key associated with a user, index transactions associated with the user in a distributed transaction ledger using at least one of the public key and the private key, wherein the distributed transaction ledger is accessed via a communication device configured to communicate with one or more nodes of the distributed transaction ledger over a network and wherein the distributed transaction ledger comprises digital product purchase records associated with a plurality of entities, determine products owned by the user based on the transactions associated with the user, display one or more products owned by the user in a customer review user interface, receive a product review for a product owned by the user via the customer review user interface, generate a product review record based on the product review, and send, via the communication device, the product review record to a distributed database as an update to the distributed database.

Those skilled in the art will recognize that a wide variety of other modifications, alterations, and combinations can also be made with respect to the above described embodiments without departing from the scope of the invention, and that such modifications, alterations, and combinations are to be viewed as being within the ambit of the inventive concept.

What is claimed is:

1. A system for authenticated customer retail product review management comprising:
a communication device configured to communicate with one or more nodes of a distributed transaction ledger over a network, wherein the distributed transaction ledger comprises digital product purchase records associated with a plurality of entities;
a memory device;
a user interface device; and
a control circuit coupled to the communication device, the memory device, and the user interface device, the control circuit being configured to:
receive a private key and a public key associated with a user;
index, in the memory device, transactions associated with the user in the distributed transaction ledger using at least one of the public key and the private key;
determine products owned by the user based on the transactions associated with the user;
display, via the user interface device, one or more products owned by the user in a customer review user interface;
receive a product review for a product owned by the user via the customer review user interface;
generate a product review record based on the product review; and
send, via the communication device, the product review record to a distributed database as an update to the distributed database.

2. The system of claim 1, wherein the control circuit is further configured to:
determine sellers associated with the transactions associated with the user;
display, via the user interface device, the sellers in the customer review user interface;
receive a seller review for at least one of the sellers via the customer review user interface;
generate a seller review record based on the seller review; and
send, via the communication device, the seller review record to the distributed database as an update to the distributed database.

3. The system of claim 1, wherein the control circuit is further configured to:
receive a transaction via the user interface device;
send a record of the transaction to the distributed transaction ledger; and
index the transaction in the memory device.

4. The system of claim 1, wherein the transactions associated with the user comprise transactions containing the public key or a digital signature generated using the private key of the user.

5. The system of claim 1, wherein the distributed database comprises the distributed transaction ledger storing the digital product purchase records or a separately maintained distributed database.

6. The system of claim 1, wherein the product review record comprises one or more of a signature generated with the private key of the user and a reference to a transaction associated with the product in the distributed transaction ledger as proof of ownership of the product being reviewed.

7. The system of claim 1, wherein nodes of the distributed database are configured to verify ownership of the product prior to updating the distributed database with the product review record submitted by the user.

8. The system of claim 1, wherein nodes of the distributed database are configured to add the product review record to a new block of the distributed database that contains a hash of a previous block.

9. The system of claim 1, wherein the control circuit is further configured to:
receive an updated review for the product via the customer review user interface;
generate an updated product review record based on the updated review; and
send, via the communication device, the updated product review record to the distributed database as an update to the distributed database.

10. The system of claim 1, wherein the distributed database is configured to be indexed by a web service that converts the distributed database to web-accessible product reviews.

11. A method for authenticated review management comprising:
receiving a private key and a public key associated with a user;
index, with a control circuit and in a memory device, transactions associated with the user in a distributed transaction ledger using at least one of the public key and the private key, wherein the distributed transaction ledger is accessed via a communication device configured to communicate with one or more nodes of the distributed transaction ledger over a network and wherein the distributed transaction ledger comprises digital product purchase records associated with a plurality of entities;
determining, with the control circuit, products owned by the user based on the transactions associated with the user;
displaying, via a user interface device, one or more products owned by the user in a customer review user interface;
receiving a product review for a product owned by the user via the customer review user interface;
generating a product review record based on the product review; and
sending, via the communication device, the product review record to a distributed database as an update to the distributed database.

12. The method of claim 11, further comprising:
determining sellers associated with the transactions associated with the user;
displaying, via the user interface device, the sellers in the customer review user interface;
receiving a seller review for at least one of the sellers via the customer review user interface;
generating a seller review record based on the seller review; and
sending, via the communication device, the seller review record to the distributed database as an update to the distributed database.

13. The method of claim 11, further comprising:
receiving a transaction via the user interface device;
sending a record of the transaction to the distributed transaction ledger; and
indexing the transaction in the memory device.

14. The method of claim 11, wherein the transactions associated with the user comprise transactions containing the public key or a digital signature generated using the private key of the user.

15. The method of claim 11, wherein the distributed database comprises the distributed transaction ledger storing the digital product purchase records or a separately maintained distributed database.

16. The method of claim 11, wherein the product review record comprises one or more of a signature generated with the private key of the user and a reference to a transaction associated with the product in the distributed transaction ledger as proof of ownership of the product being reviewed.

17. The method of claim 11, wherein nodes of the distributed database are configured to verify ownership of the product prior to updating the distributed database with the product review record submitted by the user.

18. The method of claim 11, wherein nodes of the distributed database are configured to add the product review record to a new block of the distributed database that contains a hash of a previous block.

19. The method of claim 11, further comprising:
receiving an updated review for the product via the customer review user interface;
generating an updated product review record based on the updated review; and
sending, via the communication device, the updated product review record to the distributed database as an update to the distributed database.

20. The method of claim 11, wherein the distributed database is configured to be indexed by a web service that converts the distributed database to web-accessible product reviews.

21. An apparatus for authenticated review management, the apparatus comprising:
a non-transitory storage medium storing a set of computer readable instructions; and
a control circuit configured to execute the set of computer readable instructions which causes to the control circuit to:
receive a private key and a public key associated with a user;
index transactions associated with the user in a distributed transaction ledger using at least one of the public key and the private key, wherein the distributed transaction ledger is accessed via a communication device configured to communicate with one or more nodes of the distributed transaction ledger over a network and wherein the distributed transaction ledger comprises digital product purchase records associated with a plurality of entities;
determine products owned by the user based on the transactions associated with the user;
display one or more products owned by the user in a customer review user interface;
receive a product review for a product owned by the user via the customer review user interface;
generate a product review record based on the product review; and
send, via the communication device, the product review record to a distributed database as an update to the distributed database.
